(19) United States
(12) Patent Application Publication
(10) Pub. No.: US 2008/0084188 A1
(43) Pub. Date: Apr. 10, 2008

(54) Device for cooling or heating battery module

(75) Inventor: Yoshiro Shimoyama, Chiba (JP)

Correspondence Address: EDWARDS ANGELL PALMER & DODGE LLP, P.O. BOX 55874, BOSTON, MA, 02205, US

(73) Assignees: Hyundai Motor Company, Seoul (KR); Hyundai Motor Japan R&D Center, Inc., Chiba (JP); Kia Motors Corporation, Seoul (KR)

(21) Appl. No.: 11/648,311

(22) Filed: Dec. 29, 2006

(30) Foreign Application Priority Data
Oct. 2, 2006 (KR) 10-2006-0097223

(51) Int. Cl. H02J 7/04

(52) U.S. Cl. 320/150

(57) ABSTRACT

A device for cooling or heating a battery module is disclosed to uniformly lower the temperature of the battery modules, reduce the overall weight and manufacturing costs and time. The device comprises: a plurality of battery modules; a holder supportably accommodating said battery modules; at least one fan for delivering into or removing from said holder cold or hot air; and a film fixed on each of said battery modules.

### CROSS-REFERENCE TO RELATED APPLICATIONS

The present application claims priority of Korean Patent Application Number 10-2006-0097223 filed with the Korean Intellectual Property Office on Oct. 2, 2006, the disclosure of which is hereby incorporated by reference herein in its entirety.

### FIELD OF THE INVENTION

The present invention relates to a device for cooling or heating a battery module in a hybrid vehicle. More particularly, the present invention relates a device for cooling or heating a battery module in a hybrid vehicle, which comprises an insulating film to uniformly cool or heat the battery module.

### BACKGROUND OF THE INVENTION

Generally, battery modules of a hybrid vehicle are mounted in a battery module holder of the vehicle. During operation of the vehicle, battery modules are heated up. If the battery modules keep at a high temperature for a certain period of time, durability and functionality of the modules tend to be deteriorated.

As an attempt to solve this problem, a cooling apparatus has been used to provide cold air into the battery module holder in a predetermined direction. The cooling apparatus are provided with at least one intake fan that draws air into the holder or at least one exhaust fan that withdraws air from the holder.

Nevertheless, as the cold air introduced from an inlet portion of the holder passes through the battery module, the air is gradually warmed by the battery module that has been heated. In short, the cold air, while approaching an outlet portion of the holder, cannot maintain its low temperature. As a result, for example, while the modules positioned near the inlet portion are sufficiently cooled by the cold air, the modules positioned near the outlet portion are insufficiently cooled due to the warmed air.

More particularly, as illustrated in FIG. 1, when a plurality of battery modules 2 are arranged in front, middle and rear rows (A, B, and C) in a holder 1. Cold air is introduced into the holder 1 through an inlet thereof along the direction shown as an arrow in FIG. 1. The introduced cold air cools the battery modules 2 and then exits from the holder 1 through an outlet. As the cold air moves through the holder, as described above, a temperature change of the cold air occurs. Due to the temperature change of the cold air, a temperature difference between the battery modules entails although the battery modules 2 in each row emit identical thermal amount during the operation.

For instance, if twenty (20) battery modules 2 (e.g., six modules in the front row A, eight modules in the middle row B, and six modules in the rear row C) are accommodated in the holder 1, the module temperature is approximately 60° C. Provided that the cold air at about 25° C. is introduced into the battery modules 2, the temperature of the six modules in the front row A would be about 40° C., the temperature of the eight modules in the middle row B would be about 45° C., and the temperature of the six modules in the rear row C would be about 55° C. Consequently, temperature difference of 15° C. occurs between the front row A and the rear row C. In other words, the modules in the front row A are well cooled while the modules in the rear row C are poorly cooled, resulting in a significant amount of temperature difference (although a preferable temperature difference is about 10° C.).

One approach to overcome the above-described drawback, a rectifying fin 3 has been provided to each battery module 2 wherein the rectifying fin 3 is positioned towards the inlet of holder 1 (see FIG. 2). The Rectifying fin 3 serves to restrict a direct contact of the cold air with battery module 2, thereby preventing an excessive cooling of the modules disposed at the inlet side. Rectifying fin 3 also serves to delay the heating speed of the cold air while the air passes through the modules so as to suitably cool the modules disposed at the outlet side.

Such approach employs rectifying fins 3 of different size. In particular, a rectifying fin of a large size is installed in the front row A, a rectifying fin of a middle size is in the middle row B and a rectifying fin is in the rear row C.

However, such approach has a drawback in that each of the rectifying fins 3 of different size should be mounted to each module and it thus requires long time and high costs in the installation process. Particularly, a great amount of labor and work is required to insert rectifying fins 3 into certain places of holder 1.

As an alternative approach, for example, Japanese Patent Laid-open Publication No. 2000-82502 discloses a method of uniformly cooling battery modules, which employs a covering film case around a battery module. The film case around the battery module prevents the battery module from directly contacting the cold air, thereby avoiding an excessive cooling of the modules disposed near the inlet portion. The film case also delays the heating speed of the cold air while the air flows through the modules, thus allowing the modules disposed near the outlet portion to properly be cooled by the cold air.

For uniformly cooling the modules in the holder, the modules positioned near the inlet and directly exposed to the cold air are shrouded with film cases having a diameter larger than those of the film cases shrouding the modules near the outlet.

Spacers are assembled on the modules with resin films thereon. As spacers have a diameter slightly larger than those of the modules, a gap therebetween is formed. The size of the gap varies depending on the need for adjusting the heat transfer effect using the cold air.

Nevertheless, this approach has a drawback in that the space capacity of the modules varies corresponding to the size of the spacers. Accordingly, opening size of the holder containing the modules therein should also be changed corresponding to various circumferences of the modules.

Furthermore, the approach also has a drawback in terms of cooling efficiency. No dent should be made while the modules are mounted inside the holder so as to improve the assembly. However, as the resin film distantly wraps the battery, the film would have some inward dents or the like, causing cooling efficiency to be reduced due to insufficient space capacity.

Thus, there is a need for an improved device for uniformly cooling (or heating) battery modules with reduced manufacturing time and costs.

### SUMMARY OF THE INVENTION

In one aspect, the present invention provides a device for cooling or heating battery module(s). The device comprises a plurality of battery modules; a holder supportably accommodating said battery modules; at least one fan for delivering into or removing from said holder cold or hot air; and a film fixed on each of said battery modules.

Preferably, the film is a thermal conductive film. Also preferably, thermal conductivity of said film fixed on said battery module adjacent to an inlet of said holder (upstream side) is lower than that of said film fixed on said battery module disposed far away from said inlet (downstream side).

In a preferred embodiment, thickness of the film fixed on the battery module adjacent to an inlet of said holder (upstream side) may be higher than that of the film fixed on the battery module disposed far away from said inlet (downstream side).

In another preferred embodiment, more amount of films may be used to cover the upstream battery module than the downstream battery module.

In still another preferred embodiment, the film may be formed with at least one opening.

In such embodiment, area of the opening of the film fixed on the upstream battery module is smaller than that of the film fixed on the downstream battery module.

Preferably, the film may be a cylindrical-shaped resin case.

In another aspect, motor vehicles are provided that comprise a described device.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present devices will be particularly useful with a wide variety of motor vehicles.

Other aspects of the invention are discussed infra.

### BRIEF DESCRIPTION OF THE DRAWINGS

For a better understanding of the nature and objects of the present invention, reference should be made to the following detailed description with the accompanying drawings, in which:

FIG. 1 is a cross-sectional view of a device cooling or heating the battery modules without rectifying fins according to a conventional art;

FIG. 2 is a cross-sectional view of a device cooling or heating the battery modules with rectifying fins according to a conventional art;

FIG. 3 is a perspective view of resin cases according to a preferred embodiment of the present invention; and

FIG. 4 is a perspective view of a device cooling or heating the battery modules accommodated in the resin cases according to a preferred embodiment of the present invention.

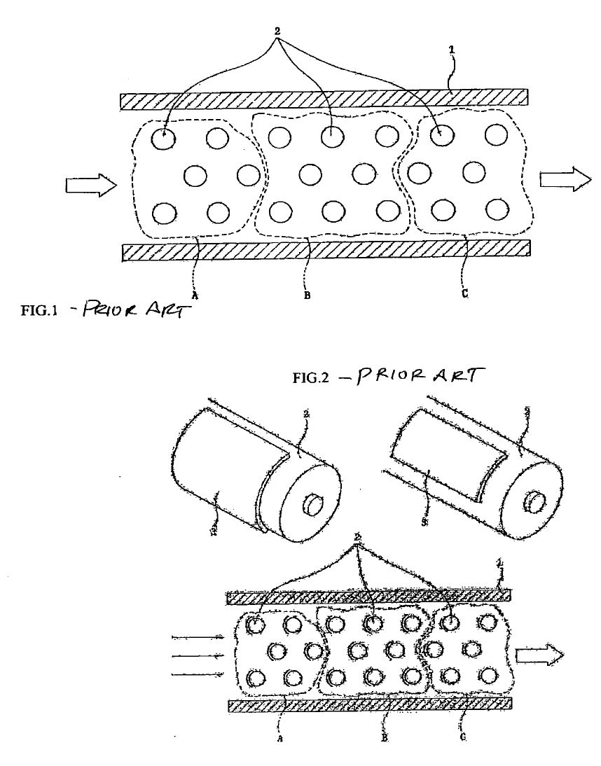

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

In one aspect, as discussed above, the present invention provides a device for cooling or heating a battery module, comprising: a plurality of battery modules; a holder supportably accommodating said battery modules; at least one fan for delivering into or removing from said holder cold or hot air; and a film fixed on each of said battery modules.

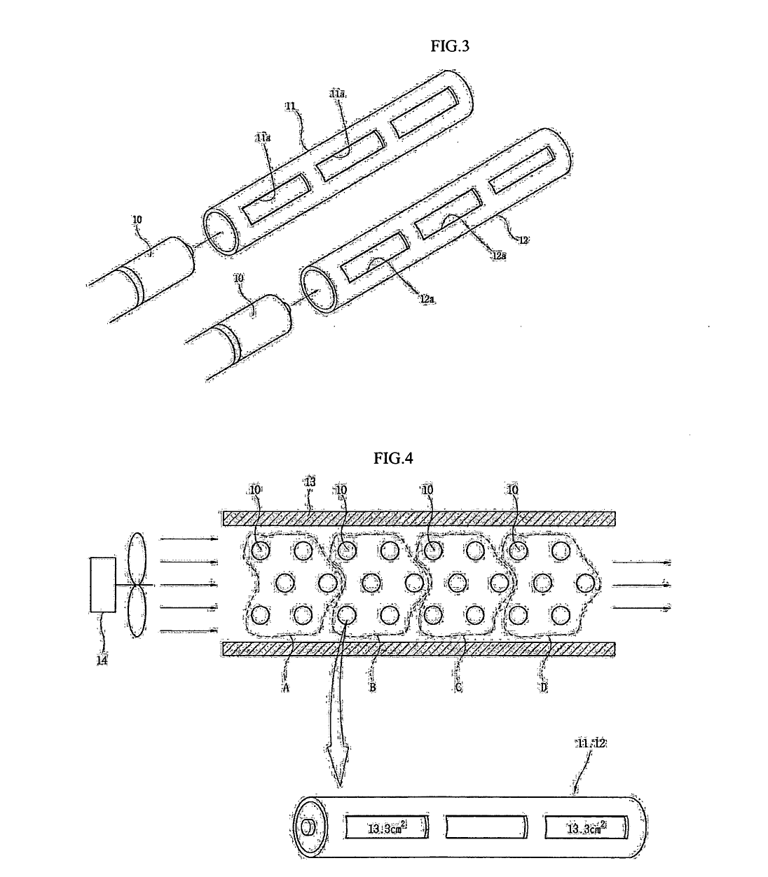

Referring to FIG. 3, each of the battery modules 10 taking the shape of a cylinder are inserted into either an insulating film having heat contractibility or a resin case 11 or 12. Resin case 11 and 12 are in cylindrical-hollow shape and they define at the circumference thereof a plurality of openings 11a and 12a.

In FIG. 3, each of resin cases 11 and 12 has, for example, three openings 11a and 12a, respectively. However, it is to be understood that the number of openings is not limited to three and may be two, four, or more. Preferably, the other side opposite to the side having the three openings may also have identical number of openings.

In a preferred embodiment, openings 11a and 12a may differ in size corresponding to the installation position of the module. For example, the battery modules at the upstream side where the cold air is taken into are covered with resin cases 12 having smaller openings 12a, while the battery modules at the downstream side where the cold air is discharged are covered with resin cases 11 having larger openings 11a. The diameter and length of resin cases 11 and 12 may preferably be identical to each other.

Referring now to FIG. 4, as the cold air is taken into a battery module holder 13 through an inlet via a cooling fan 14, the air, while passing through the battery module holder 13, lowers the temperature of battery modules 10 each of which is covered with the resin case. The air then exits from battery module holder 13.

Preferably, openings of the resin cases enclosing the battery modules may be designed to have different areas. For example, openings of the resin cases enclosing the battery modules positioned near cooling fan 14 at the upstream (A) may have an area of 40 cm², openings of the resin cases at the midstream (B) have an area of 80 cm², openings of the resin cases at the downstream (C) have an area of 120 cm², and openings of the resin cases at the down-most stream (D) have an area of 160 cm².

More particularly, each resin case at the midstream (B) may be formed with, for example, six openings, three each in two rows, and respective opening has an area of 13.3 cm² to be 80 cm² in total.

The variation of the opening area of the resin case in proportional to the distance from cooling fan 14 provided in the inlet of holder 1 prevents an excessive cooling and radiation of the battery modules adjacent to the cooling fan at the upstream (A) and leads an effective cooling and radiation of the battery modules disposed far away from the cooling fan at the down-most stream (D), thereby achieving uniform distribution of temperature of the battery modules within the battery module holder 13.

A second preferred embodiment of the present invention comprises resin cases each having different thermal conductivity corresponding to the distance from the cooling fan provided in the inlet of the holder. The resin case of the battery module near the cooling fan is implemented by an insulating film having low thermal conductivity, and the resin case of the battery module located far from the cooling fan is embodied by an insulating film having high thermal conductivity. Thus, the battery module adjacent to the cooling fan is prevented from an excessive cooling and radiation, and the battery module far away from the cooling fan performs an effective radiation.

A third preferred embodiment of the present invention comprises resin cases with insulating films identical in thermal conductivity but different in thickness corresponding to the distance from the cooling fan provided in the inlet of the holder. The resin case of the battery module near the cooling fan is thicker than that of the battery module far from the cooling fan. Thus, the battery module adjacent to the cooling fan is prevented from an excessive cooling and radiation, and the battery module far away from the cooling fan provided in the inlet performs an effective radiation.

A fourth preferred embodiment of the present invention comprises resin cases with insulating films identical in both thermal conductivity and thickness. However, more amount of resin cases are provided on the battery module near the cooling fan than the battery module far from the cooling fan. Thus, the battery module adjacent to the cooling fan is prevented from an excessive cooling and radiation, and the battery module far away from the cooling fan performs an effective radiation.

In case the opening area of the resin case differs corresponding to the distance from the cooling fan, insulating films having the same thermal conductivity and thickness are preferably used in equal amount.

Since the resin cases are in a cylindrical shape, the diameters of all the battery modules may identically be formed, thus improving the assembly of the battery modules. Also, as the resin case is closely fixed on the battery module, decrease in cooling efficiency due to insufficient space capacity is eliminated and a stable heat transfer effect is obtained.

It should be understood that the present invention may also be applied even in cold climates with a heating fan in lieu of the cooling fan so as to heat the battery modules up using the hot air.

As apparent from the foregoing, the present devices provide advantages of uniformly cooling or heating the battery modules arranged in rows in a holder, without recourse to a rectifying fin, and reducing product weight, manufacturing costs and time.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A device for cooling or heating a battery module, comprising:
a plurality of battery modules;
a holder supportably accommodating said battery modules;
at least one fan for delivering into or removing from said holder cold or hot air; and
films encompassing said battery modules respectively,
wherein said films have substantially a same outer size thereof;
wherein more sheets of films are used to cover said battery module adjacent to an inlet of said holder (upstream side) than that disposed far away from said inlet side (downstream side).

2. The device as defined in claim 1, wherein said film is a thermal conductive film.

3-7. (canceled)

8. The device as defined in claim 1, wherein said film is a cylindrical-shaped resin case.

9. A device for cooling or heating a battery module, comprising:
a plurality of battery modules;
a holder of supportably accommodating said battery modules;
at least one fan for delivering into or removing from said holder cold or hot air; and
a film fixed on films accompanying each of said battery modules respectively,
wherein said films are formed with at least one opening respectively.

10. The device as defined in claim 9 wherein said area of said opening of said film fixed on said battery module adjacent to an inlet of said holder (upstream side) is smaller than that of said film fixed on said battery module disposed far away from said inlet (downstream side).

11. The device as defined in claim 9 wherein said film is a cylindrical-shaped resin case.
